(19) United States
(12) Patent Application Publication
(10) Pub. No.: US 2017/0155767 A1
(43) Pub. Date: Jun. 1, 2017

(54) METHODS CIRCUITS DEVICES SYSTEMS AND ASSOCIATED COMPUTER EXECUTABLE CODE FOR PROVIDING DIGITAL SERVICES

(71) Applicant: David COHEN, Herzeliya (IL)

(72) Inventor: David COHEN, Herzeliya (IL)

(21) Appl. No.: 15/319,826

(22) PCT Filed: Jun. 15, 2015
(86) PCT No.: PCT/IL2015/050604

§ 371 Date: Dec. 19, 2016

Related U.S. Application Data
(63) Continuation-in-part of application No. 14/461,464, filed on Aug. 18, 2014, now abandoned.
(60) Provisional application No. 62/014,188, filed on Jun. 19, 2014.

(30) Foreign Application Priority Data
Dec. 25, 2014 (IL) 236485
Jan. 19, 2015 (IL) 236807

(51) Int. Cl. H04M 3/51

(52) U.S. Cl. CPC H04M 3/5175; H04M 3/5191

(57) ABSTRACT

The present invention includes methods, circuits, devices, systems and associated computer executable code for providing or otherwise facilitating digital and/or interactive services, for example to a communication device such as a mobile communication device. The present invention may also include methods, circuits, devices, systems and associated computer executable code for associating and optionally synchronizing voice and data communication sessions. According to some embodiments, a voice call between a communication device, such as a smartphone, and a telephonic appliance, such as for example an Interactive Voice Response (IVR) appliance or Call/Support Center Station associated with a service provider, may trigger a digital service to the communication device.

### FIELD OF THE INVENTION

The present invention relates generally to the field of communications. More specifically, the present invention relates to methods, circuits, devices, system and associated computer executable code for providing digital services, optionally by bridging an audio communication session with a data communication session.

### BACKGROUND OF THE INVENTION

Almost all of the mobile phones produced today include both voice and data communication capabilities and are generally referred to as smartphones. The smartphone is becoming the main device used to access the Internet and online services. Although a significant portion of the developed world's population is becoming accustomed to managing many of its services online, voice calls are still a dominant mode of communication when it comes to inquiring about and ordering goods and/or services. Voice calls are also used to report problems and request corrective measures. Leveraging of the dual communication modalities available on communication devices to providing synergistic interaction between voice calls and digital services is, however, for the most part still unavailable.

### SUMMARY OF THE INVENTION

The present invention includes methods, circuits, devices, systems and associated computer executable code for providing or otherwise facilitating digital and/or interactive services, for example to a communication device such as a mobile communication device. The present invention may also include methods, circuits, devices, systems and associated computer executable code for associating and optionally synchronizing voice and data communication sessions. According to some embodiments, a voice call between a communication device, such as a smartphone, and a telephonic appliance, such as for example an Interactive Voice Response (IVR) appliance or Call/Support Center Station associated with a service provider, may trigger a digital service to the communication device. The digital service may include digital and/or multimedia content provided to the mobile communication device, and the digital service may include an interactive service triggered and/or otherwise guided by a computer, computing device, computing platform or computer system functionally related to the called service provider. For example, according to embodiments, a conventional voice call from a smartphone running software according to embodiments of the present invention to a telephonic appliance associated with a service provider having a computational device or platform according to the present invention may enable the computing device functionally associated with the service provider to gain digital access to one or more applications running on the smartphone and to perform actions including but not limited to: (1) pushing content for audio rendering (i.e. speaker) circuits and/or video rendering (i.e. display) circuits on the smartphone, (2) controlling one or more services and/or applications installed on the cellphone, (3) installing one or more services and/or applications onto the smartphone, (4) accessing and extracting data from the smartphone or from one or more sensors of the smartphone or applications that utilizes these sensors (e.g., GPS, camera, magnetometer, accelerometer, digital compass, etc.), and (5) configuring and/or reconfiguring service and/or application of the smartphone.

Computational platforms or systems, including computational devices and optionally data network communication devices, adapted to access and provide digital services to a communication device in accordance with embodiments of the present invention may be referred to as a Digital Service Bridge (“DSB”). A DSB may be implemented within or otherwise functionally associated with a computer workstation of a service provider (e.g. customer service representative computer workstation), such that an operator of the workstation may trigger and/or guide a digital, optionally interactive, service provided to a communication device in accordance with embodiments of the present invention. A DSB may also be implemented within or otherwise functionally associated with an autonomously operating computer platform such as a computer server and/or an Interactive Voice Response System (IVR), such that the triggering and/or guidance of a digital, optionally interactive, service provided to a communication device in accordance with embodiments of the present invention may be automatic in accordance with computer executable instructions and optionally responsive to inputs provided by a user of the communication device. The DSB may be implemented as part of a distributed architecture such that a networked DBS appliance integral or functionally associated with a service provider's telephony/data network(s) provides either operator workstations or automated servers/IVR's digital service connectivity to a communication device in accordance with embodiments. The DSB may even be implemented as a service or application on a mobile communication device called by the communication device to receive digital service.

Network access to the communication device and its resources and applications may be provided in accordance with several different methodologies. According to some embodiments, a voice call made from a mobile communication device, such as a smartphone, may trigger generation of a digital access token, access data string and/or other access indicator (hereinafter referable to as “access token”) which may be usable by an external computing device, such as a DSB associated server or workstation, in order to gain digital access to the mobile communication device and to interact with one or more resources, services and/or applications running on the mobile communication device. The access token may either be directly transmitted over a distributed data network (e.g. mobile data network) to a specific external device or may be stored in a networked token repository or cache which is accessible by any one of a set of possible external computing devices through a network such as the Internet. According to embodiments, each access token may include or otherwise be linked to a phone identifier (e.g. phone number, etc.) of the mobile device which either generated or otherwise triggered generation of the access token. The token may also include credentials for accessing the communication device. The token may also include encryption keys and/or parameters for accessing the communication device. The token may also include network addresses and/or network parameters for accessing the communication device. Accordingly, a voice-call made from a mobile communication device to a telephonic appliance associated with a DSB according to embodiments may facilitate, via generation and/or transfer or the access token, a communication data link between an external computing device (e.g. DSB) functionally associated with the telephonic appliance and a resource, service and/or application installed on the mobile communication device.

A communication device according to embodiments may include computer executable code running in operating memory of the communication device, which code may include a dial pad module, a dial pad detection or interception module and/or a dialed number detection/interception module adapted to determine which phone number is being dialed by a user of the communication device. A lookup module of the computer executable code may determine whether a dialed number is associated with a called service provider having telephonic appliances with session bridging and/or digital access capabilities according to embodiments of the present invention. A token provider module of the computer executable code on the mobile communication device may provide an access token by: (a) generating one, (b) selecting one from a token storage, (c) modifying an existing stored access token, and/or (d) causing another application either running on the communication device or on a functionally associated server to perform any one or more of (a) through (c). An access token according to embodiments may be a provisional access token including data which may define which resources on the mobile communication device may be accessed. The provisional access token may further include data indicating a period of time, or a window of time, during which access to one or communication device resources may be granted. Additionally, the access token may be encrypted using a public encryption key of an intended user of the access token, thereby limiting use of the token to parties having a corresponding private encryption key.

An access token according to embodiments may include various parameters required to establish a network connection to a mobile communication device connected to the public Internet through a mobile communication network. The access token may include such parameters as the communication device's current public IP address and/or port numbers being monitored by and/or being routed to the mobile communication device. The access token may include a mobile device ID used by an application on the mobile communication device when registering itself on a gatekeeper server. According to further embodiments, the access token may include credentials and/or digital keys for gaining access to one or more resources and/or applications running on the mobile communication device. Whether connecting to a given mobile communication device directly or via a gateway, an application running on an external computing device, such as a DSB and/or functionally associated device, may use an access token associated with the given communication device to gain access to one or more resources and one or more applications on the given communication device, thereby enabling the external computing device application to provide content and/or interactive services to the given mobile communication device.

The lookup module, upon receiving a detected dialed phone number. may access, reference and/or retrieve from either an internal or externally stored data table or database information for call/service providers with digital/interactive service equipment and/or capabilities according to the present invention. Included with or otherwise linked to each provider's record(s) may be a network (e.g. IP) address for the provider and possibly a public encryption key corresponding to a private encryption key used by the provider. A provider's network address may be used in order to transmit an access token directly to the provider. A provider's public encryption key may be used to encrypt an access token and thus limit use of a token to the provider whose public encryption key was used.

It should be clear that any function mentioned as being performed by computer executable code on the communication device may likewise be performed by an application running on a networked computing platform communicatively coupled to the mobile communication device for which the token is generated. It should likewise be clear that any functionality described as being performed by one functional element associated with the digital service or digital interactive service provider may be performed by any number of other networked appliances programmed to perform that function.

According to some embodiments, there may be provided service provider equipment which may include or more of the following: (1) telephonic appliances or equipment adapted to receive one or more voice calls from one or more communication devices; (2) call handling equipment adapted to derive from at least some of the calls a communication device identifier of the calling device, for example a calling mobile communication device's phone number; (3) networked computing devices or platforms adapted to utilize a derived communication device identifier associated with a received voice call to receive, look for and/or optionally retrieve an access token of the communication device which launched the received voice call; (4) network computing devices or platforms adapted to utilize retrieved access tokens in gaining access to the communication device which launched the received voice call; and (5) network computing devices or platforms adapted to gain access to the communication device which launched the received voice call without the use of a token. Any combination of the above listed equipment, whether embodied as a discrete device or set of devices, or whether embodied as code running on multipurpose computing devices or platforms, may be referred to as a digital service bridge (“DSB”).

According to further embodiments, there may also be provided call routing equipment adapted to route received voice calls along with corresponding identifiers and/or with retrieved access tokens to: (1) a service representative (e.g. CRM) workstation, (2) a call waiting queue, and/or (3) an interactive voice response system having digital service capabilities according to embodiments of the present invention. According to embodiments, a service provider's workstation and/or an IVR may either include and/or be functionally associated with a networked computing device or platform, such as a DSB, adapted to facilitate through a network such as the Internet a digital and/or interactive service(s) for a communication device, optionally using an access token associated with the communication device. The digital/interactive service(s) may be substantially automated and driven by a software application running on the external computer device or platform. The digital/interactive service(s) may be manually guided by a human operator of a service provider workstation. The digital/interactive service may include both automatically and manually triggered digital interactions between the service provider and the communication device.

There may be provided an online registry server where a computing device associated with a service provider according to embodiments of the present invention may register information to indicate to a communication device that the service provider is able to provide a digital service according to embodiments. The information stored for a given service provider may be useable by a communication device to facilitate a digital service between the service provider and the communication device. The registry may receive from a service provider and store information useable to generate and or provide an access token for the specific provider. A record or records for a provider may include information such as: (1) a given provider's public encryption key, (2) a given provider's network address and parameters to which access tokens may be directly transmitted and/or saved for subsequent retrieval, and (3) parameters required by the given provider for integration into the access token, for example the mobile communication device's identifier and/or MAC address. The registry may receive from a service provider and store information, such as network addresses and protocols, useable by a communication device to locate and access network gatekeeper servers and/or network gateways through which the service provider may initiate a digital service to the communication device. The online registry server may be accessed by a lookup module of a communication device according to embodiments.

The communication device may access a networked gatekeeper server adapted to mediate a communication link between the communication device and a DSB of interest. The gatekeeper server network location and access protocols may be predefined in software running on the communication device, or may be defined in a registry record accessed by the communication device. A service provider's DSB may also communicate with the gatekeeper, continuously or in response to receiving a voice call from the communication device. The gatekeeper may mediate a digital service connection between the communication device by providing each with the other's relevant network address information and session initiation parameters. Once a direct data connection between the communication device and the service provider DSB is mediated by the gatekeeper, the gatekeeper may terminate communication with the communication device and optionally with the service provider DSB, and the DSB may provide a digital service to the communication device via the direct data connection.

The communication device may access a networked gateway adapted to bridge and/or support a communication link between the communication device and a DSB of interest. The gateway network location and access protocols may be predefined in software running on the communication device, or may be defined in a registry record accessed by the communication device. A service provider's DSB may also communicate with the gateway, continuously or in response to receiving a voice call from the communication device. The gateway may connect a digital service connection between the communication device and the DSB by providing each with the relevant session initiation parameters. The gateway may maintain communication with and between the communication device and the service provider DSB during a digital service session.

According to some embodiments, a communication device may transmit, over a secure encrypted data link, an access token to either a predefined server of a given service provider or to a server identified within a registry record for the given service provider. The access token may be generated by the communication device or by another device functionally associated with the communication device. The token may be based on or derived from an existing reference token, or it may be generated specifically for a specific digital service session with the given service provider. Access tokens may include such parameters as a service provider identifier, a session time window identifier, one or more communication device resource access identifiers or credentials, a session identifier and/or any other identifiers which may uniquely identify and distinguish the token from other tokens.

A communication device according to embodiments may generate or trigger the generation of an access token for a specific service provider and/or for a specific digital service session with the specific service provider, and may transmit the token directly to a network address specifically associated with the service provider and/or the service provider's DSB. According to further embodiments, a token may be transmitted to an online token repository accessible by the service provider's network equipment, for example the provider's DSB.

According to embodiments, there may be provided an online token repository in which an access token generated by or for a communication device according to embodiments may be deposited for subsequent retrieval by computational equipment of one or more service providers, for example by a DSB functionally associated with the service provider. An access token, provisional or otherwise, may be deposited by a mobile communication device which has, is or will be engaged in a voice call with a service provider according to embodiments of the present invention. A deposited token may include or be otherwise linked with an identifier of the mobile communication device which caused the token to be generated and/or deposited. Optionally, a deposited token may include an indicator for which service provider it is intended. According to further embodiments, a deposited token may further include an indicator of the token's useful, valid and/or non-expired, time period(s) during which the token may be accepted by the communication device with which it is associated in order to gain access to that communication device, it's applications and/or resources. Regardless of whether an access token is transmitted directly to a service provider or retrieved by the provider from a repository, the networked computational device or platform functionally associated with the service provider's telephonic equipment may use the information contained in the token to try to establish a direct networked connection with the communication device and to provide digital services to the communication device such as content and/or interactivity.

A DSB according to embodiments of the present invention may include a data communication module adapted to transmit data to, and optionally to receive data from, a communication module of a communication device such as a mobile communication device. Data exchanged between the mobile communication device and the DSB of the service provider may facilitate digital services to the communication such as pushed digital content (e.g. audio and video), and/or configuration, definition, triggering and/or directing of interactive service to the mobile communication device. The interactive services which may be provided according to embodiments of the present invention may include but are not limited to: (1) inquiring with regard to one or more goods or services, (2) requesting or ordering one or more goods or services, (3) making account related inquiries, (4) arranging bill payments, and/or (5) reporting service problems.

According to embodiments, pushed digital content may include entertainment or advertising content pushed to a caller's cellphone while they are waiting for a customer service representative. According to further embodiments, a service provider may push cross-marketing content to a caller while they are waiting in queue. According to yet further embodiments, a service provider may have or be associated with an online advertisement marketplace for advertisers bidding to push ads to people waiting on their phones for service.

According to further embodiments, a communication device with a dial pad module and lookup module according to embodiments may run software adapted to solicit, store and provide feedback in connection with a dialed number. The application may check an online reviews database to which user may provide comments or reviews in connection with good and/or services provided via a given phone number. Phone number associated comments may include: (1) likes or dislikes, (2) quality of service rating, (3) pricing related information, (4) reliability related information, and/or (5) any other information which may be relevant for a potential customer or client when deciding whether to transact business with a business to which the number is associated. Comments, reviews and/or statistics characterizing the reviews (e.g. pricing, QOS, reliability, etc.) may be presented on the communication device screen as the number is dialed. The software may also allow the communication device user to provide and post their comments and/or reviews to the database.

According to further embodiments, the software may check whether any of the comments or reviews on the database, associated with a specific number, where provided by a contact of the communication device user, and may indicate so to the user. This may be achieved by correlating records on the communication device's contacts list with numbers associated with provided comments/reviews. The software may provide instant communication or messaging facilities between two or more users of the software, optionally between a person dialing a given number and another person who previously posted a review in connection with the given number.

According to some embodiments, the DSB or an associated IVR of a provider may be configured to, upon receiving a call from a communication device, send an SMS or other message format to the communication device, which message may include a link to a server where software according to embodiments may be downloaded. The link may be to an application marketplace, such as the App Store or google play store, or may be to a dedicated download server. The software may include some or all of the modules required to engage in a digital service session according to embodiments. The software may include the interceptor, token generator, lookup module, digital service communication module, and a digital interactive service application manager. Upon clicking the link in the message, the software may install and the communication device may start receiving a digital service from the provider.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a system level diagram illustrating the constituent components, and signal flow there between, of an exemplary system for providing interactive services according to embodiments of the present invention;

FIG. 1B is a flowchart including the steps of an exemplary method executable by a system such as the one illustrated in FIG. 1A;

FIG. 2A is a system level diagram illustrating the constituent components, and signal flow there between, of an exemplary system for providing interactive services according to embodiments of the present invention;

FIG. 2B is a flowchart including the steps of an exemplary method executable by a system such as the one illustrated in FIG. 2A;

FIG. 3A is a system level diagram illustrating the constituent components, and signal flow there between, of an exemplary system for providing interactive services according to embodiments of the present invention;

FIG. 3B is a flowchart including the steps of an exemplary method executable by a system such as the one illustrated in FIG. 3A;

FIG. 4A is a system level diagram illustrating the constituent components, and signal flow there between, of an exemplary system for providing interactive services according to embodiments of the present invention;

FIG. 4B is a flowchart including the steps of an exemplary method executable by a system such as the one illustrated in FIG. 4A;

FIG. 5 is a functional block diagram illustrating exemplary functional modules of a mobile communication device adapted according to embodiments of the present invention;

FIGS. 6A & 6B are functional block diagrams illustrating exemplary functional modules of an interactive session bridge according to embodiments of the present invention; and

FIG. 7 is a functional block diagram of an embodiment of the present invention where a dial pad input interceptor module and associated application are adapted to solicit, store and provide feedback in connection with a dialed number.

FIG. 8 schematically illustrates an exemplary screen layout in form of a map that include representation of a reported event to an emergency service center by multiple callers, according to an embodiment of the invention;

FIG. 9 schematically illustrates an exemplary screen layout of a mobile app adapted to interact with an emergency service center using the digital services, according to an embodiment of the invention;

FIG. 10 schematically illustrates an exemplary screen layout of a detailed reported event provided by the mobile app of a specific caller of FIG. 9, according to an embodiment of the invention;

FIG. 11 schematically illustrates an exemplary screen layout of the mobile app of FIG. 9 during an interaction with the emergency service center using the digital services, according to an embodiment of the invention;

FIG. 12 schematically illustrates a network access to a mobile communication device from a terminal device, according to an embodiment of the invention; and

FIG. 13 schematically illustrates an establishment of a peer-to-peer communication between two users, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Terms in this application relating to distributed data networking, such as send or receive, may be interpreted in reference to Internet protocol suite, which is a set of communications protocols that implement the protocol stack on which the Internet and most commercial networks run. It has also been referred to as the TCP/IP protocol suite, which is named after two of the most important protocols in it: the Transmission Control Protocol (TCP) and the Internet Protocol (IP), which were also the first two networking protocols defined.

According to some embodiments of the present invention, mobile devices may connect with and access data from an enterprise data system over a communication network at some portion of which may be a wireless network. While the term wireless network may technically be used to refer to any type of network that is wireless, the term is most commonly used to refer to a telecommunications network whose interconnections between nodes is implemented without the use of wires, such as a computer network (which is a type of communications network). Wireless telecommunications networks are generally implemented with some type of remote information transmission system that uses electromagnetic waves, such as radio waves, for the carrier and this implementation usually takes place at the physical level or “layer” of the network. (For example, see the Physical Layer of the OSI Model). Various wireless technologies and standards exist, including:

Global System for Mobile Communications (GSM): The GSM network is divided into three major systems which are the switching system, the base station system, and the operation and support system (Global System for Mobile Communication (GSM)). The cell phone connects to the base system station which then connects to the operation and support station; it then connects to the switching station where the call is transferred where it needs to go (Global System for Mobile Communication (GSM)). This is used for cellular phones, it is the most common standard and is used by a majority of cellular providers.

Personal Communications Service (PCS): PCS is a radio band that can be used by mobile phones in North America. Sprint happened to be the first service to set up a PCS.

D-AMPS: D-AMPS, which stands for Digital Advanced Mobile Phone Service, is an upgraded version of AMPS but it is being phased out due to advancement in technology. The newer GSM networks are replacing the older system.

Wireless MAN—metropolitan area network.

Wireless LAN—local area networks.

Wireless PAN—personal area networks.

GSM—Global standard for digital mobile communication, common in most countries except South Korea and Japan.

PCS—Personal communication system—not a single standard, this covers both CDMA and GSM networks operating at 1900 MHz in North America.

Mobitex—pager-based network in the USA and Canada, built by Ericsson, now used by PDAs such as the Palm VII and Research in MotionBlackBerry.

GPRS—General Packet Radio Service, upgraded packet-based service within the GSM framework, gives higher data rates and always-on service.

UMTS—Universal Mobile Telephone Service (3rd generation cell phone network), based on the W-CDMA radio access network.

AX.25—amateur packet radio.

NMT—Nordic Mobile Telephony, analog system originally developed by PTTs in the Nordic countries.

AMPS—Advanced Mobile Phone System introduced in the Americas in about 1984.

D-AMPS—Digital AMPS, also known as TDMA.

Wi-Fi—Wireless Fidelity, widely used for Wireless LAN, and based on IEEE 802.11 standards.

Wimax—A solution for BWA (Broadband Wireless Access) and conforms to IEEE 802.16 standard.

Canopy—A wide-area broadband wireless solution from Motorola.

Free Space Optics (FSO) is a telecommunication technology that uses light propagating in free space to transmit data between two points. The technology is useful where the physical connection of the transmit and receive locations is difficult, for example in cities where the laying of fiber optic cables is expensive. Free Space Optics is also used to communicate between space-craft, since outside of the atmosphere there is little to distort the signal. The optical links usually use infrared laser light, although low-data-rate communication over short distances is possible using LEDs. IrDA is a very simple form of free-space optical communications. Distances up to the order of 10 km are possible, but the distance and data rate of connection is highly dependent on atmospheric conditions.

The present invention includes methods, circuits, devices, systems and associated computer executable code for providing or otherwise facilitating digital and/or interactive services, for example to a communication device such as a mobile communication device. The present invention may also include methods, circuits, devices, systems and associated computer executable code for associating and optionally synchronizing voice and data communication sessions. According to some embodiments, a voice call between a communication device, such as a smartphone, and a telephonic appliance, such as for example an Interactive Voice Response (IVR) appliance or Call/Support Center Station associated with a service provider, may trigger a digital service to the communication device. The digital service may include digital and/or multimedia content provided to the mobile communication device, and the digital service may include an interactive service triggered and/or otherwise guided by a computer, computing device, computing platform or computer system functionally related to the called service provider. For example, according to embodiments, a conventional voice call from a smartphone running software according to embodiments of the present invention to a telephonic appliance associated with a service provider having a computational device or platform according to the present invention may enable the computing device functionally associated with the service provider to gain digital access to one or more applications running on the smartphone and to perform actions including but not limited to: (1) pushing content for audio rendering (i.e. speaker) circuits and/or video rendering (i.e. display) circuits on the smartphone, (2) controlling one or more services and/or applications installed on the cellphone, (3) installing one or more services and/or applications onto the smartphone, (4) accessing and extracting data from the smartphone, and (5) configuring and/or reconfiguring service and/or application of the smartphone.

Computational platforms or systems, including computational devices and optionally data network communication devices, adapted to access and provide digital services to a communication device in accordance with embodiments of the present invention may be referred to as a Digital Service Bridge (“DSB”). A DSB may be implemented within or otherwise functionally associated with a computer workstation of a service provider (e.g. customer service representative computer workstation), such that an operator of the workstation may trigger and/or guide a digital, optionally interactive, service provided to a communication device in accordance with embodiments of the present invention. A DSB may also be implemented within or otherwise functionally associated with an autonomously operating computer platform such as a computer server and/or an Interactive Voice Response System (IVR), such that the triggering and/or guidance of a digital, optionally interactive, service provided to a communication device in accordance with embodiments of the present invention may be automatic in accordance with computer executable instructions and optionally responsive to inputs provided by a user of the communication device. The DSB may be implemented as part of a distributed architecture such that a networked DBS appliance integral or functionally associated with a service provider's telephony/data network(s) provides either operator workstations or automated servers/IVR's digital service connectivity to a communication device in accordance with embodiments. The DSB may even be implemented as a service or application on a mobile communication device called by the communication device to receive digital service.

Network access to the communication device and its resources and applications may be provided in accordance with several different methodologies. According to some embodiments, a voice call made from a mobile communication device, such as a smartphone, may trigger generation of a digital access token, access data string and/or other access indicator (hereinafter referable to as “access token”) which may be usable by an external computing device, such as a DSB associated server or workstation, in order to gain digital access to the mobile communication device and to interact with one or more resources, services and/or applications running on the mobile communication device. The access token may either be directly transmitted over a distributed data network (e.g. mobile data network) to a specific external device or may be stored in a networked token repository or cache which is accessible by any one of a set of possible external computing devices through a network such as the Internet. According to embodiments, each access token may include or otherwise be linked to a phone identifier (e.g. phone number, etc.) of the mobile device which either generated or otherwise triggered generation of the access token. The token may also include credentials for accessing the communication device. The token may also include encryption keys and/or parameters for accessing the communication device. The token may also include network addresses and/or network parameters for accessing the communication device. Accordingly, a voice-call made from a mobile communication device to a telephonic appliance associated with a DSB according to embodiments may facilitate, via generation and/or transfer or the access token, a communication data link between an external computing device (e.g. DSB) functionally associated with the telephonic appliance and a resource, service and/or application installed on the mobile communication device.

According to embodiments, there is provided a system for providing a digital service on a mobile communication device, said system may include a dial pad or dialer interception module to detect a phone number dialed at the mobile communication device. A lookup module may check whether the detected number is associated with a digital service and may retrieve digital service initiation parameters associated with an associated digital service. The system may include a digital service communication module on the mobile communication device, and the module may be adapted to engage in a digital service communication session with, and receive digital service from, a digital service communication module on service provider equipment. Said digital service communication module is adapted to engage in the digital service communication session either directly with the service provider or through a digital service gateway.

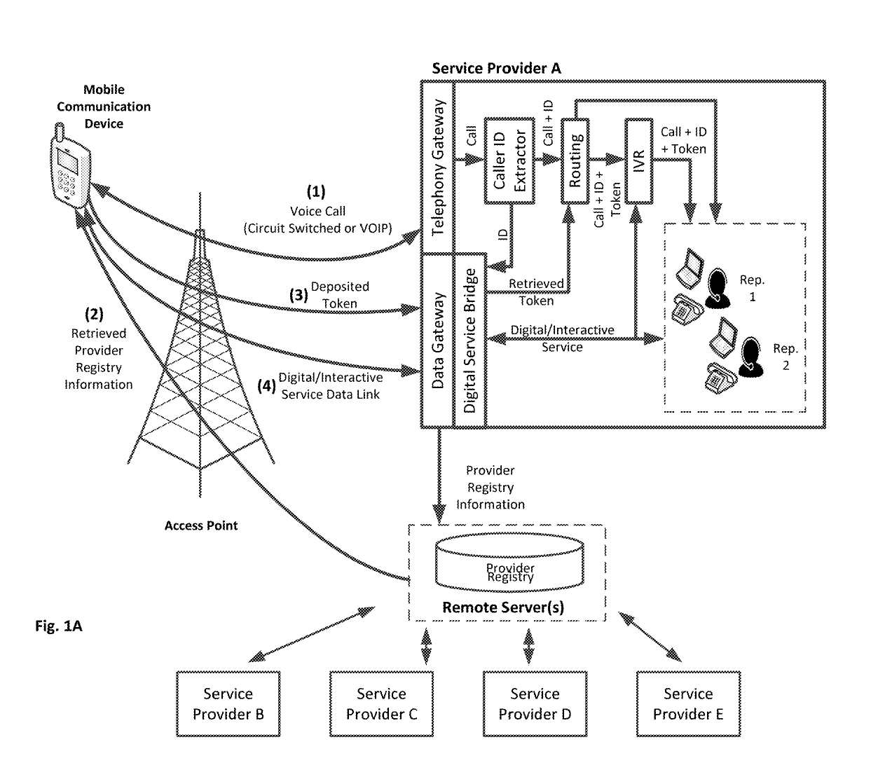

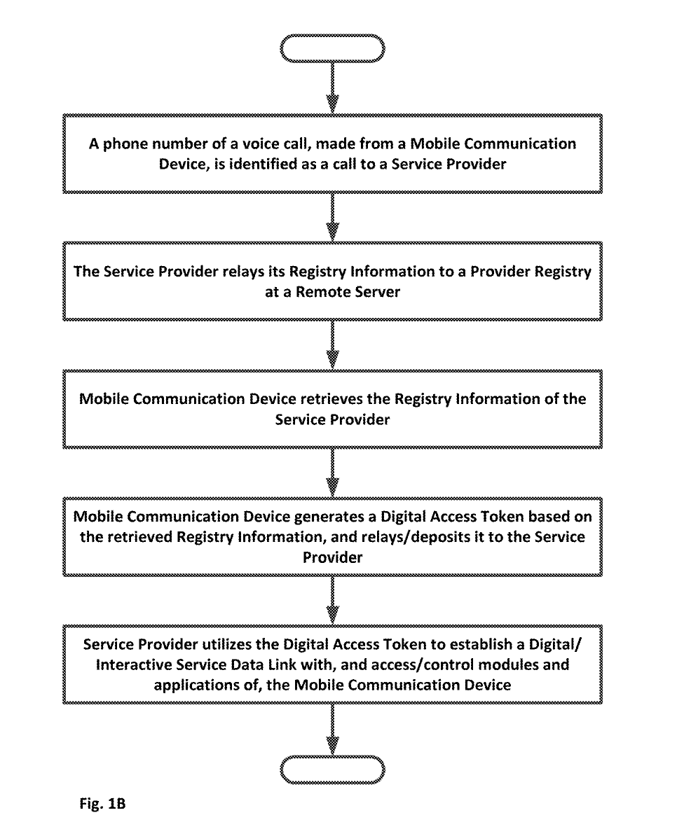

Turning now to FIG. 1A, there is shown a system level diagram illustrating the constituent components, and signal flow there between, of an exemplary system for providing interactive services, wherein an access token generated by a Mobile Communication Device is deposited directly with a corresponding Service Provider. A Mobile Communication Device on a voice call references a Provider Registry, accessible and intermittently updated by Service Provider(s), on a Remote Server(s). If Provider Registry records corresponding to an identifier of the voice call (e.g. the dialed number) exist, the call is determined to be a call with a Service Provider, and Provider Registry information associated with the respective Service Provider is retrieved by the Mobile Communication Device. The retrieved Provider Registry information is used by the Mobile Communication Device to generate an access token, communicate it over a data link to a destination provided as part of the retrieved Provider Registry information and deposit it with the respective Service Provider. The Service Provider utilizes the token for establishing a digital/interactive data link with the Mobile Communication Device, and/or for accessing, monitoring, activating or the like one or more Mobile Communication Device software applications and/or hardware components.

In FIG. 1B there is shown a flowchart including the main steps of an exemplary method executable by a system such as the one illustrated in FIG. 1A and described above.

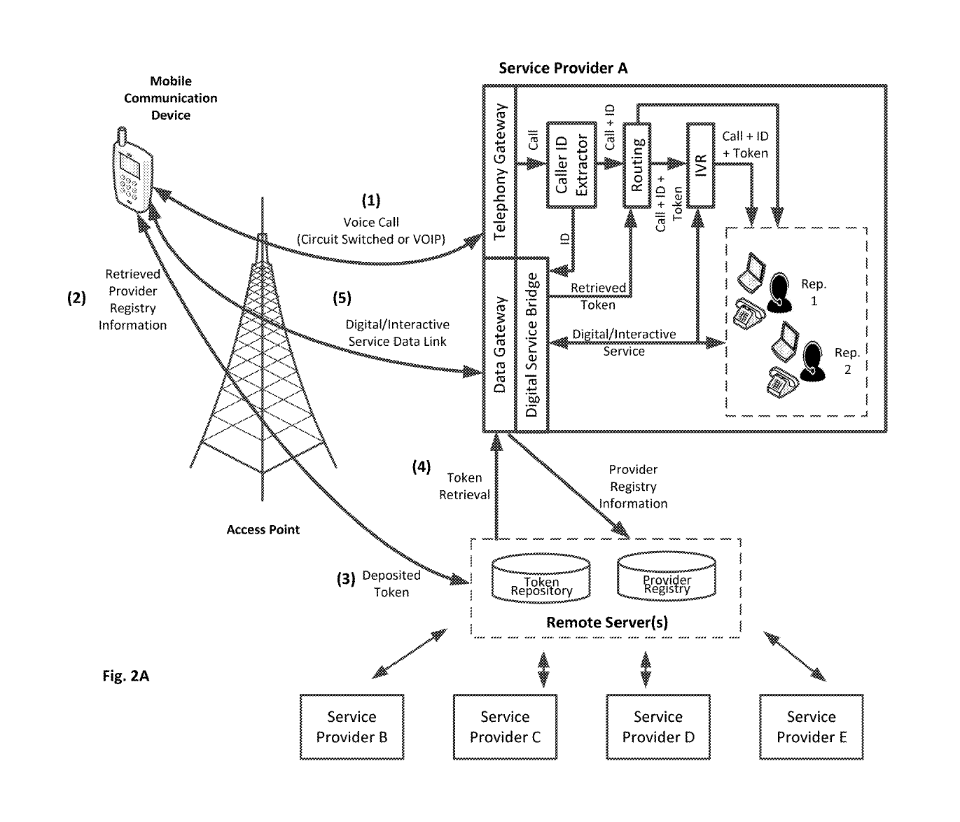

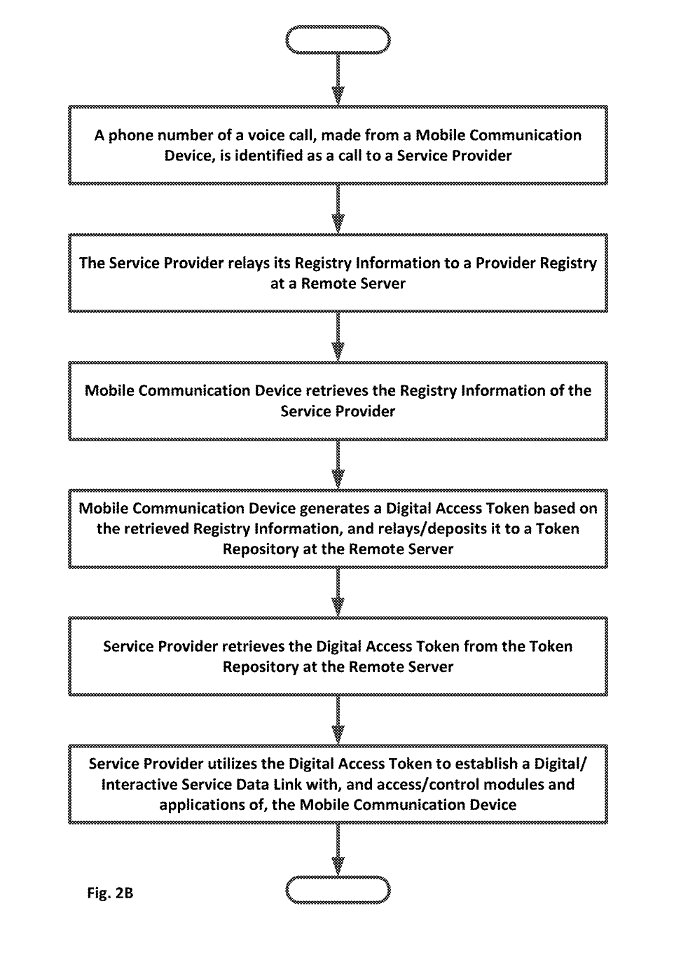

Turning now to FIG. 2A, there is shown a system level diagram illustrating the constituent components, and signal flow there between, of an exemplary system for providing interactive services, wherein an access token generated by a Mobile Communication Device is deposited with a Token Repository for a corresponding Service Provider to retrieve. A Mobile Communication Device on a voice call references a Provider Registry, accessible and intermittently updated by Service Provider(s), on a Remote Server(s). If Provider Registry records corresponding to an identifier of the voice call (e.g. the dialed number) exist, the call is determined to be a call with a Service Provider, and Provider Registry information associated with the respective Service Provider is retrieved by the Mobile Communication Device. The retrieved Provider Registry information is used by the Mobile Communication Device to generate an access token, communicate it over a data link, and deposit it with a Token Repository, at a destination known to both the Mobile Communication Device and the respective Service Provider, or at a destination provided as part of the retrieved Provider Registry information. The respective Service Provider retrieves the deposited access token from the Token Repository and utilizes the token for establishing a digital/interactive data link with the Mobile Communication Device, and/or for accessing, monitoring, activating or the like, one or more Mobile Communication Device software applications and/or hardware components.

In FIG. 2B there is shown a flowchart including the main steps of an exemplary method executable by a system such as the one illustrated in FIG. 2A and described above.

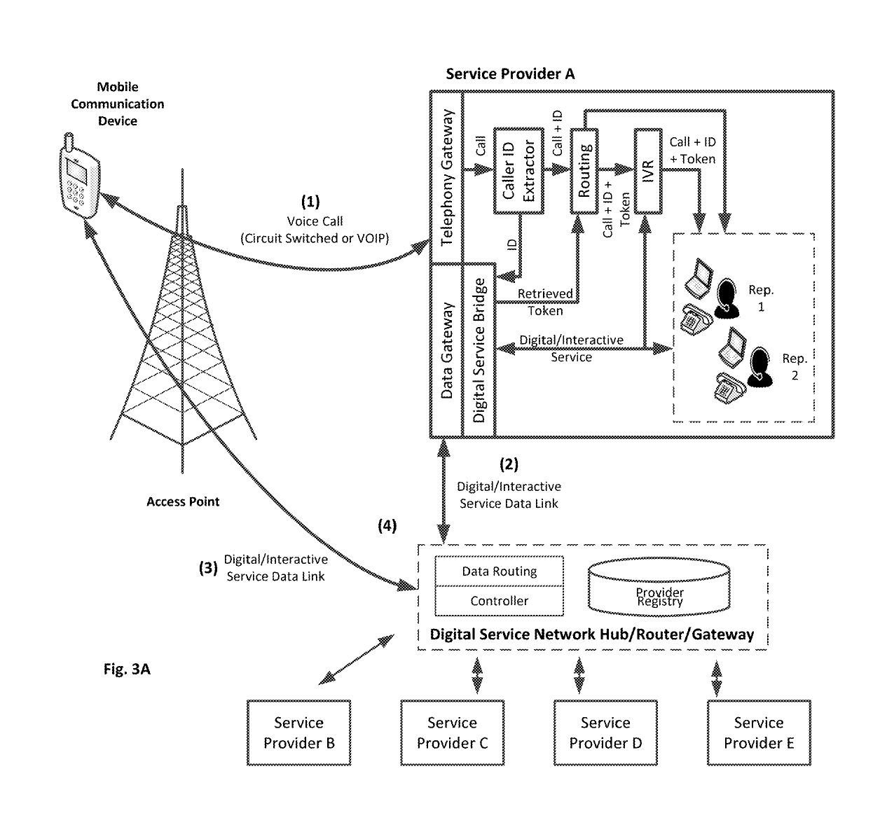

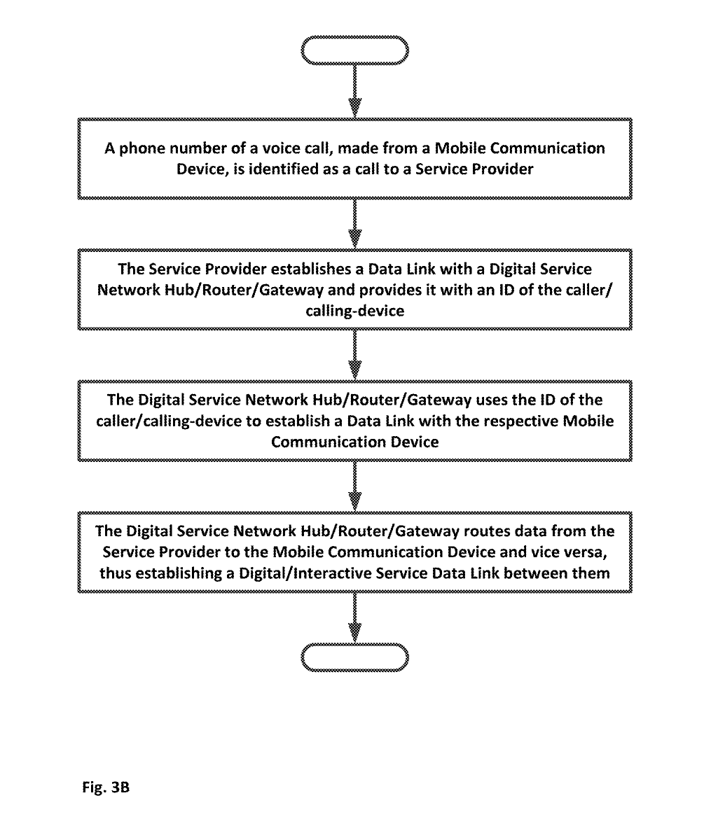

Turning now to FIG. 3A, there is shown a system level diagram illustrating the constituent components, and signal flow there between, of an exemplary system for providing interactive services, wherein the digital service is provided to the communication device through a gateway known to both the communication device and the service provider. An access token generated by a Mobile Communication Device may be communicated to, and deposited with, a corresponding Service Provider through a Digital Service Network Router. A Mobile Communication Device on a voice call references a Provider Registry on a Remote Server(s) functionally associated with a Digital Service Network Router. If Provider Registry records corresponding to an identifier of the voice call (e.g. the dialed number) exist, the call is determined to be a call with a Service Provider, and Provider Registry information associated with the respective Service Provider is retrieved by the Mobile Communication Device. The retrieved Provider Registry information is used by the Mobile Communication Device to generate an access token, and communicate it over a data link to the Digital Service Network Router. The Digital Service Network Router utilizes a Data Routing Module to route and communicate the access token, and deposit it with the respective Service Provider, at a destination known to the Digital Service Network Router. The respective Service Provider utilizes the token for accessing, monitoring, activating or the like, one or more Mobile Communication Device software applications and/or hardware components, over a digital/interactive data link with the Mobile Communication Device through, and routed by, the Digital Service Network Router.

In FIG. 3B there is shown a flowchart including the main steps of an exemplary method executable by a system such as the one illustrated in FIG. 3A and described above.

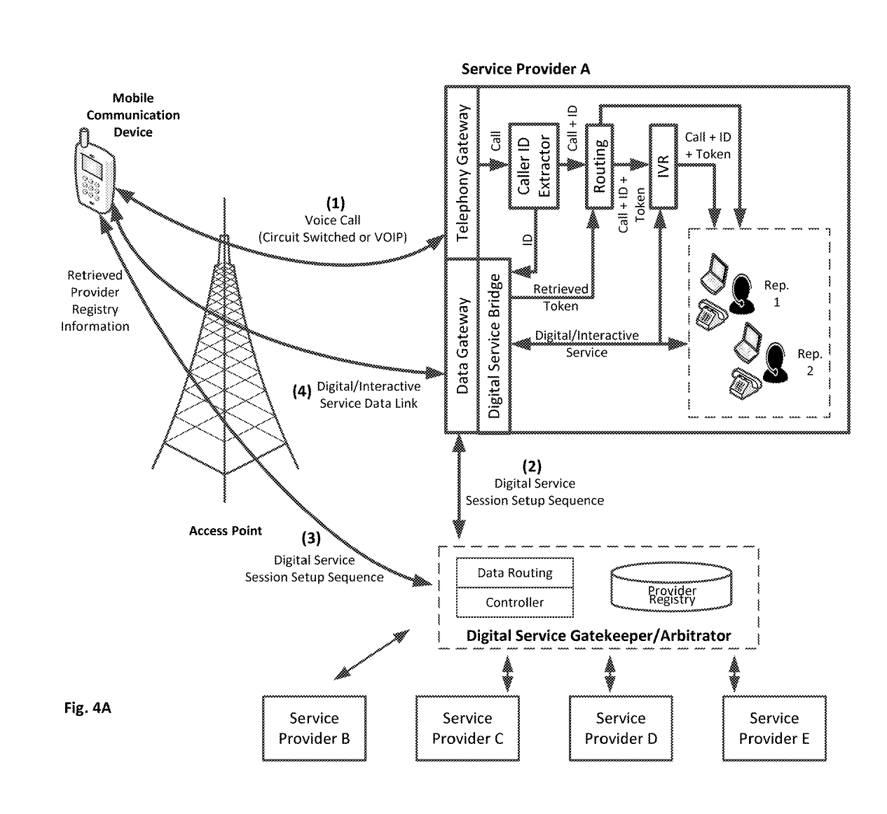

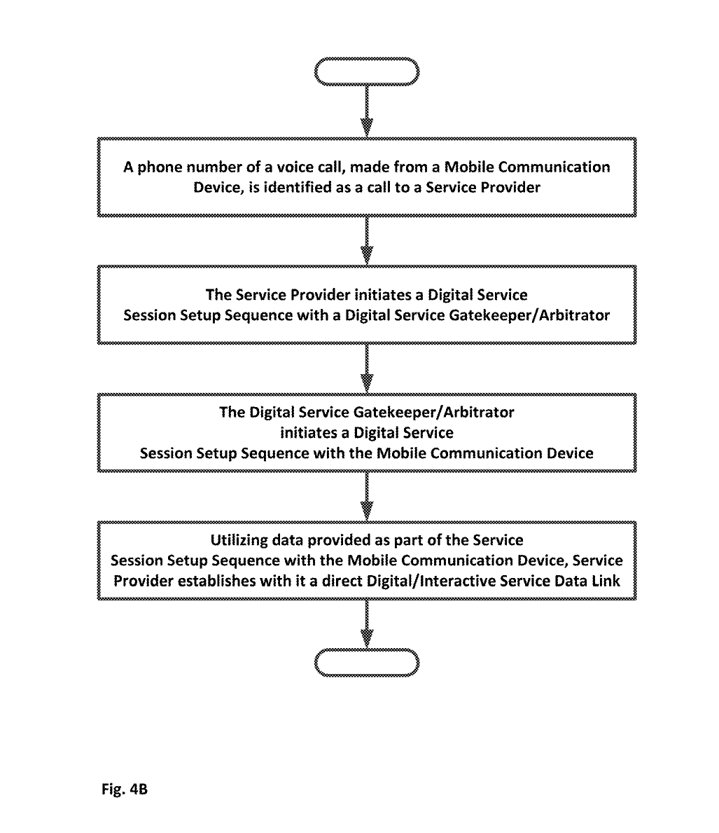

Turning now to FIG. 4A, there is shown a system level diagram illustrating the constituent components, and signal flow there between, of an exemplary system for providing interactive services, wherein a digital service session is established through a gatekeeper which mediates a direct communication session between the communication device and the Digital Service Bridge (DSB). According to embodiments, an access token generated by the mobile communication device is communicated to, and deposited with, a corresponding Service Provider through a Digital Service Gatekeeper. A Mobile Communication Device on a voice call references a Provider Registry on a Remote Server(s) functionally associated with a Digital Service Gatekeeper. If Provider Registry records corresponding to an identifier of the voice call (e.g. the dialed number) exist, the call is determined to be a call with a Service Provider, and Provider Registry information associated with the respective Service Provider is retrieved by the Mobile Communication Device. The retrieved Provider Registry information is used by the Mobile Communication Device to generate an access token, and communicate it over a data link to the Digital Service Gatekeeper. The Digital Service Gatekeeper utilizes a Data Routing Module to route and communicate the access token, deposit it with the respective Service Provider, at a destination known to the Digital Service Gatekeeper, and initiate a digital service session setup sequence between the respective Service Provider and the Mobile Communication Device. The respective Service Provider utilizes information generated as part of the digital setup sequence for establishing a direct (not through the Digital Service Gatekeeper) digital/interactive data link with the Mobile Communication Device, and/or utilizes the access token for accessing, monitoring, activating or the like one or more Mobile Communication Device software applications and/or hardware components.

In FIG. 4B there is shown, a flowchart including the main steps of an exemplary method executable by a system such as the one illustrated in FIG. 4A and described above.

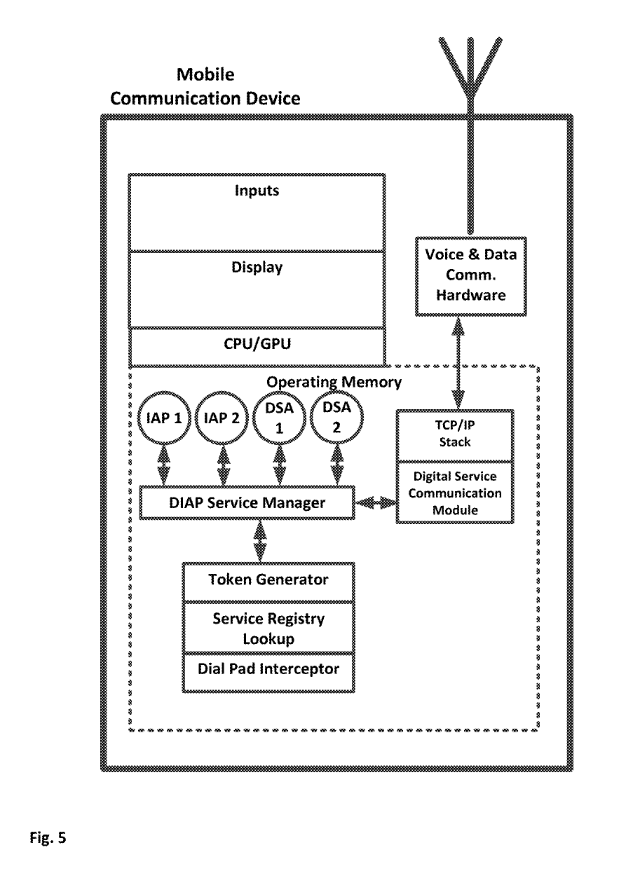

Turning now to FIG. 5, there is shown a functional block diagram illustrating exemplary functional modules of a mobile communication device adapted according to embodiments of the present invention. The device includes a dial pad interceptor, a token generator, a digital service communication module, and a digital service application manager.

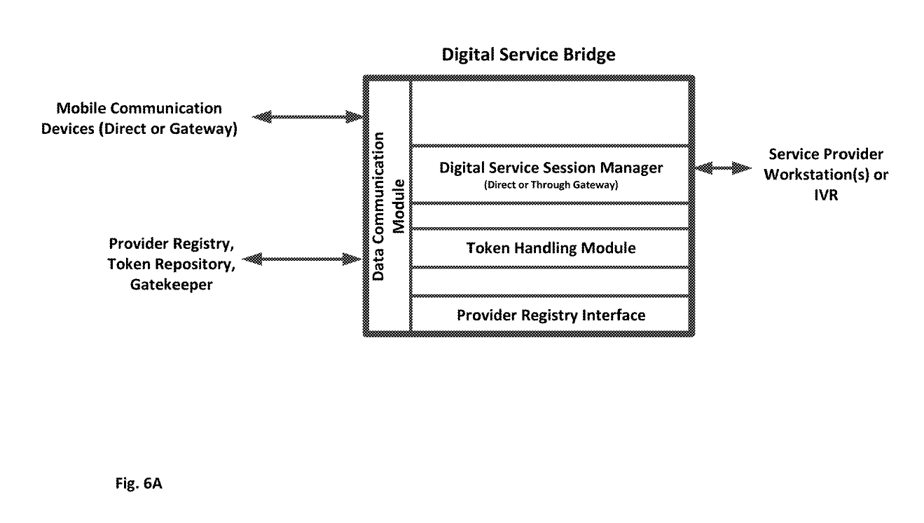

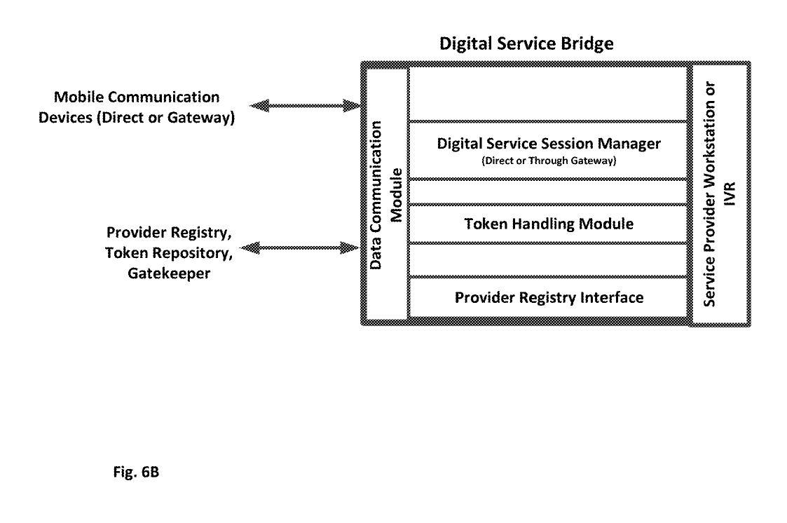

Turning now to FIGS. 6A & 6B, there are shown functional block diagrams illustrating exemplary functional modules of an interactive session bridge according to embodiments of the present invention. FIG. 6A shows an embodiment where the Digital Service Bridge (DSB) is discrete from the workstation, application server and/or IVR which drives the digital service session. FIG. 6B shows an embodiment where the Digital Service Bridge (DSB) is integral with the workstation, application server and/or IVR's which drives the digital service session.

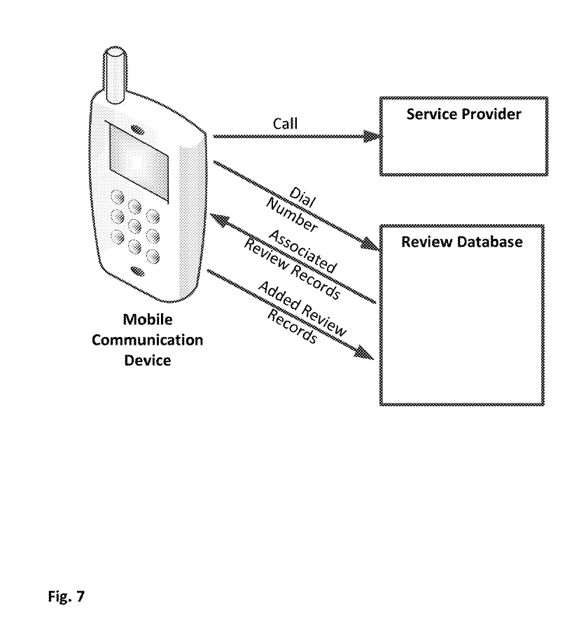

Turning now to FIG. 7, there is shown a functional block diagram of an embodiment of the present invention where a dialer or dial pad input interceptor module and associated application are adapted to solicit, store and provide feedback in connection with a dialed number.

According to an embodiment of the invention, the system can be used to improve emergency services such as 911 by utilizing sensors and applications available on mobile phones.

With the digital services provided by the method and system of the present invention, it has been made possible to use multimedia services for emergency services rather than strictly voice services, e.g., for 911 calls. The digital services can use images, video, audio and data transmissions in addition to the traditional voice transmission. As the traditional voice transmission may overlap the audio provided via data transmissions of the digital services, one of the voice channels may be muted (e.g., the audio provided through the data transmission can be muted). It must be noted that audio from either channels that is muted but may be recorded for a further analysis.

An operator at the emergency center, e.g., a human operator (i.e., a first responder) at the 911 dispatch center, has to respond to the emergency in an appropriate manner within a very short time. This involves asking specific questions from the caller to infer the type of emergency and then to decide on a course of action. For example, protocols provide a method to standardize this process across all 911 emergency centers. The operators handling the 911 calls use standard protocols, called Dispatch Protocols, to answer the calls for help. These protocols guide the operator about what questions to ask and what actions to take during a given emergency. The information regarding the event, which the operator has retrieved using said dispatch questions in real time, is limited due to the nature of human witness capabilities of reporting an emergency event, as well as the limited ability of an operator to compose a coherent and crisp understanding of the event, especially while trying to form executable information from multiple sources which might be halted and/or incomplete and/or conflicting.

When dialing an emergency service such as 911, the mobile device, in addition to the aforementioned embodiments, sends information comprising GPS bearings that may include all or combination of information deriving from said GPS including but not limited to physical location coordinates, altitude, azimuth, etc., and/or corresponding bearings information deriving from other available sources such as WiFi, cellular network, etc., and/or sensors. The GPS bearing information may be processed, either at the mobile device or at a remote server, for providing a corresponding address or other relevant information that can be calculated, extracted or retrieved from said GPS bearing information. The GPS bearing information may be further used to send navigation information to terminal devices of other parties such as an ambulance driver, rescue teams, etc. Furthermore, upon dialing said emergency service the mobile device may automatically or manually open a video camera as well as an audio channel to be transmitted via data channel routed to the system's server, as the voice call is being connected via a typical telephone network such as the public switched telephone network (PSTN) or alike.

The system is a critical tool in the toolbox of early responders and the like. As such and in order to allow it to operate even in the harshest of conditions an additional information channel is being provided as to assure a fallback position if the data channel is unable to act in accordance with the embodiments presented. According to an embodiment of the invention, when a phone call is being made to an emergency center (e.g., 911) upon the establishment of the conversation, the information (such as the GPS readings and any other information/data deemed important) is converted into audible form (i.e., audio data packets) to be transmitted over the voice channel (at any frequencies deemed to be appropriate for a voice channel communication), as to allow receiving party to obtain crucial information concerning the calling party even if the data channel has not been established, corrupted. The audible form is critical as in many cases calling party is unable to provide coherent verbal information concerning his whereabouts, etc. The audible data is decrypted and associated to the calling party as to allow rapid situation awareness concerning the event. A checksum test or alike may be used to verify the integrity of the audio data. If the audio data fails to meet predetermined criteria of various types (e.g., background noises that may corrupt the audio data delivery), the receiving party may generate an audible request for retransmitting of the audio data. The audio data package may contain visual information (e.g., an image as described hereinabove), as to allow a full system functionality even if the data is not available.

The video and/or audio data can be stored locally on the mobile device as well as the location data. In order to prevent corruption of the stored data (e.g., due to battery failure or mechanical damage), an auto saving mode can be continuously applied. The stored information can be used for later transmission or analysis in case data channel is not available or limited. Once data connection has been established the data is being sent in accordance to the capacity of an available data channel. The system's server may remotely set the number of video frames per second (FPS) to be sent from each mobile device (5 FPS instead of 30 FPS) and/or reduce the resolution quality of the frames and/or limit the allocated bandwidth. In addition the screen brightness can be controlled either remotely by the server or locally by the app in order to save power consumption of the mobile device. The above mentioned restrictions concerning the usage of mobile phone resources may be activated automatically according to the remaining battery power of the mobile device.

The app may instruct the user of the mobile device to point the camera of the mobile device to the event location, either visually or vocally by utilizing the speaker of the mobile phone. An on screen indicator (e.g., may appear as a circle) enabling the user to easily focus on the point of interest (POI) while viewing the event as appear on the screen of the mobile device. Location data including azimuth etc., might be presented on the screen of the mobile device to be visible to the user.

The app may include tutorials for different emergency events, thereby in case of distinct emergency such as a person needs a CPR, Heimlich maneuver, etc., a video with a verbal torturing might be presented on the display of the mobile device prior to verbal engagement with the operator. In case the mobile device user wants to point out the camera to an object while viewing the tutorial a split screen can be activated for displaying both the camera recordings and the tutorial. In case the operator wants to share data with the user (e.g., a video tutorial at the operator side), it can be displayed on a split screen on the mobile device.

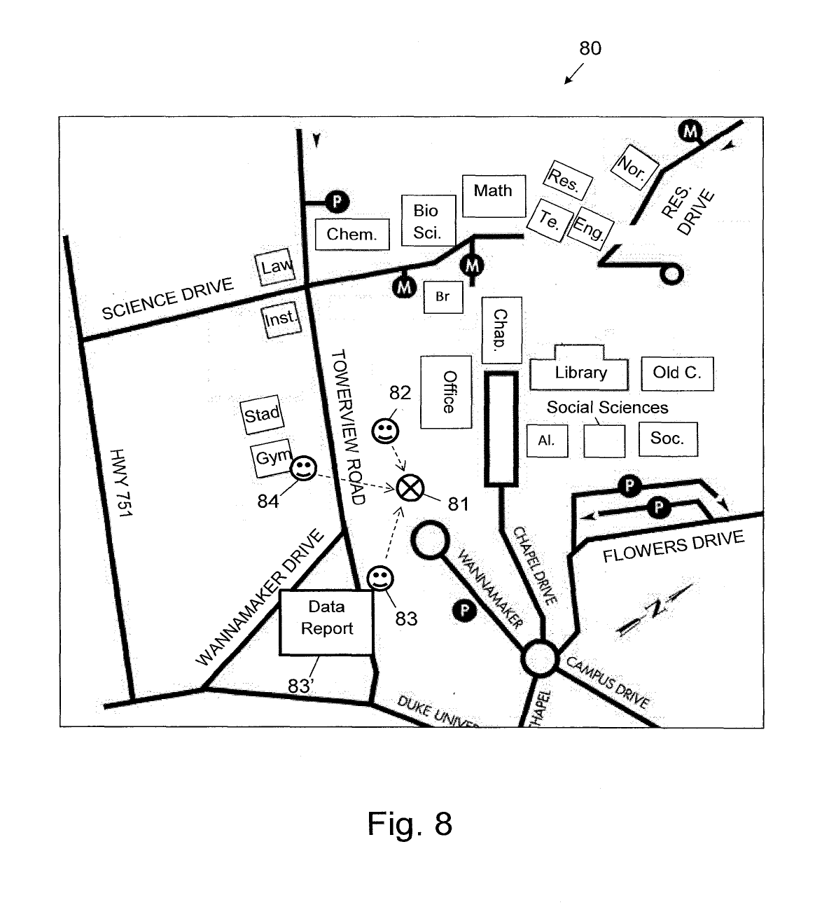

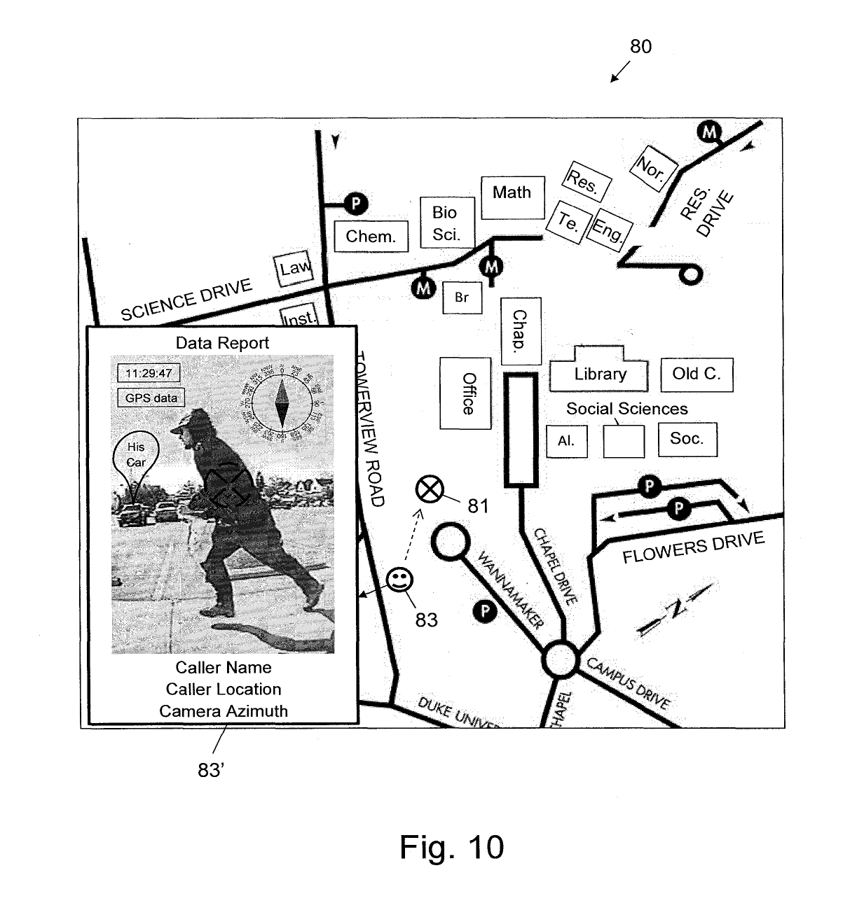

As the operator receives the emergency call, the streamed information will appear on the operator's screen, as shown for example in FIG. 8. Information can be presented on a map 80 to allow operator to immediately associate information with physical location and surroundings, such as access roads, visual layers that may include images and photos of actual objects located/related to a reported event (e.g., as the event indicated by numeral 81), textual and/or iconic report data that may include coordinates, elevation, azimuth, timestamp, image captured by a caller, whether the caller is offline or online and available for further interaction (e.g., such online/offline indicator can be obtained by green and red colored icon respectively), etc., (e.g., as indicated by numeral 83′ of caller 83 and best seen in FIG. 10), visualization of audio data associated with the reported event (e.g., analyzing a recorded audio stream and extracting suspicious sounds such as gun shoot pattern and representing the same, e.g., by a special icon on map 80), visualization of the perspective view (i.e., orientation) from which the caller who report the event is shown map 80 (e.g., as indicated by the dotted arrow assigned to each caller 82, 83 and 84). Event 81 may be focused on map 80, and the desired displayed region can be set automatically or manually (e.g., by defining the desired radius around the event as a region of interest, or by enabling a zoom in/out feature).

When more than one caller calls for the same event, each caller point of view will be shown on the map to provide a real perspective view of the event (e.g., as indicated by the dotted arrow associated with each caller 82-84) including chronological time line related to each caller. Each sighting may appear with a different color indicator wherein the most recent event will be colored red for example, while previous event will be colored blue. Color scheme may consist of multiple colors as to enable an easy visual understanding of the chronological time line of events. Parts of the display information can be cropped manually or automatically and be sent to a third party or a database for evaluation. For example, a caller streams a robbery in progress wherein the face of the perpetrator is visible. The operator can capture the face of the suspect and send it out to an FBI data center for receiving possible match up information. Such information is imperative in real time if the suspect has a known history of using force against law enforcement agents.

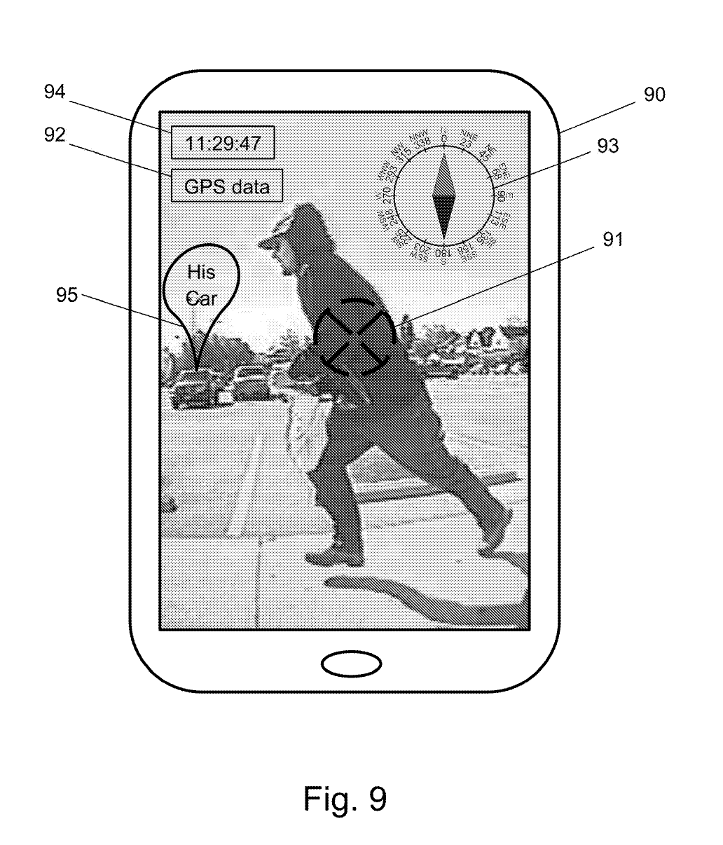

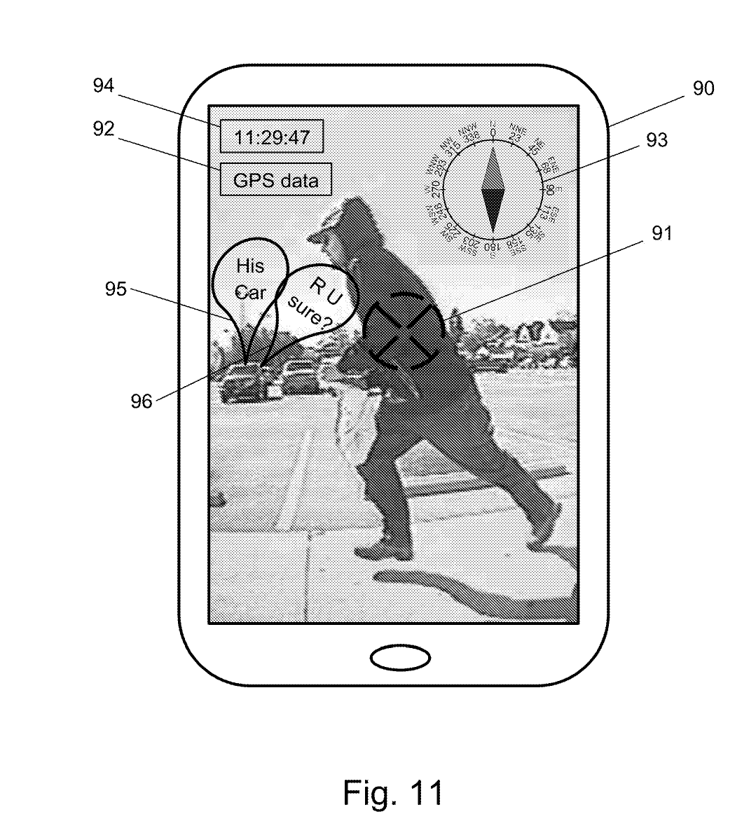

The visual indicator that appears on the user's mobile device will be also visible to the operator, in order to guide the user of the mobile device. FIGS. 9 and 10 show an exemplary crime event, wherein on the user's mobile device 90 information regarding the event location and orientation with respect to the suspect as indicated by numeral 93, timing as indicated by numeral 94, GPS data readings as indicated by numeral 92 and the visual indicator as indicated by numeral 91. The app may include a feature that allows the user to add pinpoint tags on the screen for helping the operator to focus on items of interest in the event (e.g., as the text that point on the suspect's car “His car” as indicated by numeral 95). The operator may reply to the caller on the captured image with a comment of his own to clarify intent of message, e.g., as indicated by numeral 96 in FIG. 11. The messaging may appear in different color/shape/font type or as typical messaging scroll window for the caller and the operator to easily distinguishes the source of the message. Information concerning medical data (e.g., associated with a caller) will be available to the operator. According to an embodiment of the invention, data received from multiple callers can be shared/accessed among several operators or on a main display. The system allows the operator to route the communication channel (voice and data) to a terminal device of a first responder that actually and locally handle the event.

According to an embodiment of the invention, the system may route the emergency call to any number of emergency services, such as police, medical services, fire fighters, etc., in accordance with the geographical location of the mobile device. People involve in emergency situations may not be able to convey their actual location to an emergency call responder, due to stress, impaired physical condition, environmental factors such as background noises or poor quality of communication channel. Furthermore, due to the above mentioned inherent limitations, the caller may not convey in a coherent and efficient manner the details of the event.

Moreover, in emergency events multiple callers may report the same event presenting responder with conflicting information due to the fact that event is being observed from different physical point of view, i.e., actual physical locations with respect to the same event that may consist different perspectives such as GPS readings, viewing angle (different azimuth), elevations and different chronographic exposure to the event. For example, FIG. 8 schematically illustrates a map of a given area on which a specific event is indicated by numeral 81 as well as the different callers 82, 83 and 84 wherein each of them observes event 81 from different physical point of view. Said discrepancies in an attempt to describe the same event may prevent first responders from developing a coherent situation awareness of the actual event, and hence pressure may be lost.

According to a further embodiment of the present invention, in addition to the aforementioned embodiments, the system further includes an app and a corresponding back-office infrastructure to enable an efficient and coherent report mechanism based on the above mentioned technology, that will enable early responder (e.g., 911 dispatcher at an emergency center and/or actual early responders at or on their way to the event location) to receive a coherent and clutter proof information of the event.

Data string sent from said mobile device may include GPS readings and/or other tracking/location indicators, as well as predetermined information associated with the user, such as blood type, age, sensitivity to medications, medical records, person's name, etc. This information might be stored in the mobile device or as data records stored on a server associated with the system to be sent from either the mobile phone or from the server.

Implementing the system and digital services of the present invention, the Dispatch Protocols can be modified to make use of the digital services to make the process of handling emergency calls more efficient. The method and services suggested by the present invention turns mobile phones into personal devices with several embedded sensors. In the present disclosure, the sensors in a mobile phone are used for collecting sensor data and transmitting them to the emergency center (e.g., such as the 911 dispatcher). For example, an accelerometer and a magnetometer, embedded in a mobile phone, can be used to provide the exact orientation of the mobile phone as the user moves the device (i.e., a digital compass) either directly or a compass app that combines the heading information from the magnetometer with the roll and pitch data from the accelerometer. For certain functions, such as longitude and latitude location data, the compass app may use the mobile phone integrated GPS technology or other available location tracking services. Other sensors embedded in the mobile phone can also be used to provide data to the emergency center such as, microphone, camera, etc., either individually or by combining data from two or more sensors. In addition, some mobile phone sensors can be used to get vital signs, e.g., by providing the readings of heart rate.

According to an embodiment of the invention, in case location/tracking data form GPS or location tracking services is not available the system uses information previously obtained by the mobile phone, sending last known location. The mobile phone can store multiple tracking/location data to enable the regeneration of route up to the moment of data transmission. Said data can be stored on the mobile device in accordance to a data storage process that collects information continuously. In another aspect, the mobile phone can store multiple tracking/location data to enable the regeneration of route up to the moment of data transmission. Said data can be stored on the mobile device in accordance to a data storage process that collects information continuously, wherein said information is limited to a certain data capacity by number of data records, data volume, data collection time, etc., to be collected in a FIFO manner.

The effectiveness of the digital services will be dependent upon several different factors. One of the most important measures of the success would be the reduction in time it takes for an operator to decide the level of seriousness of the incident and dispatch help. This can be obtained by starting the recording of sensors' data before the operator at the emergency center even answers the call. The initiating of the call to the emergency service or other service can be executed as described hereinabove, or by activating an app icon located on the touch screen display of the mobile phone, wherein said app automatically initiates the voice call and digital services of the present invention. It must be noted that the app can be operated by other input means such as voice command, wherein a word associated with an emergency/distress situation may trigger the app.

In another aspect, the app may initiate an emergency call upon detecting a predetermined pattern that indicates a vehicle accident. Such a predetermined pattern can be extracted from GPS readings concerning speed and mobile phone sensors such as accelerometers reading indicating a vector change off said mobile device consistent of a vehicle accident. For example, if GPS readings indicates speed of 50 miles per hour at specific vectors and specific “G” force readings and then abruptly speed drops to zero as the “G” force readings indicates an extreme change on at least one axis, the app may assume that an accidiend has occurred and accordingly trigger the app to initiate an emergency call. The app may record FIFO audio data, e.g., last 30 seconds, wherein at said emergency event information is send to the emergency center to be evaluated in real time indicating the nature of the event.

Another factor is the number of transactions involved. Many questions that an operator has to ask the caller during a voice call may become redundant in a digital service using data sensor including audio and video components. So the number of questions eliminated is another measure of effectiveness. Another factor is bandwidth. Many of the vital signs may be measured by the cell phone sensors and can also be automatically transmitted. The amount of such data that can be automatically sent to the operator would be another measure. The quality of decision making and quality of service at the dispatch center are factors that should also improve. This can be measured by several factors like a reduction in the number of un-needed dispatches, and an increase in the number of lives saved.

An emergency call may be made by the affected people themselves. Such people may be facing cognitive impairment or even physical impairment. The operator answering the call goes through several steps during the call. During a voice call, the operator is dependent on the caller to give an accurate description of the problem and answer all the questions correctly. The operator may then have several instructions for the caller to help him while the dispatch personnel arrive at the scene. The operator is again dependent on the caller to follow the instructions. The operator does not have an easy way to judge if the instructions are being followed accurately or if they are helping. But in the case of the digital services provided by the present invention, the operator can follow the caller much more easily, can see the scene of the incident, and can also see if the instructions are being followed.

This embodiment also relates to measurement of vital signs of human using mobile phones, including a method for estimating blood pressure utilizing a mobile phone equipped with sensors and applications.

According to an embodiment of the present invention, the system provides an encrypted Voice-over-IP (VoIP) channel. In one aspect the VoIP can be activated by disconnecting the regular mobile voice communication, and reestablishing the voice communication via the system's server in a secure and encrypted manner (e.g., using VPN, SSL protocols). Alternatively, the user may choose to route the conversation through the VoIP form the beginning when selecting a contact from his contacts list or directly when dialing a number. The encrypted VoIP can be routed directly between two parties associated with the service, or via a server that directs the non-associated party to the associated party. In that the associated party access the system's server (e.g., using IVR) and accordingly provides the number of the party he wishes to contact or the IVR to execute a phone call that is one way encrypted. Therefore, instead of being transmitted over a circuit-switched network, the digital information is packetized, and transmission occurs as IP packets over a packet-switched network. Such transmission entails careful considerations about resource management different from time-division multiplexing (TDM) networks.

Such ability is very important as it known that mobile voice communications are vulnerable to security breaches of the voice communications, unauthorized access to the voice communications, and other problems. Incorporation of mobile devices (often using disparate mobile phone networks and operating systems) into the information technology (IT) infrastructure of a business or enterprise has proven to be problematic with regard to both integration and security. For example, mobile devices can carry important information (and data) and communication on the mobile device can create a security leak of the information (and data) on the mobile device. Voice communication on a mobile device can be eavesdropped by a third party to the mobile device and the mobile phone network (e.g., hackers of the mobile phone network, employees, consultants, or vendors of the operators of the mobile phone network, or anyone else or anything else having access to the communication between the mobile device and the mobile phone network, such as tower operators, infrastructure providers, and backhaulers). As a result, the encrypted VoIP channel provided by the present invention provides an essential encryption solution for end-to-end mobile voice communications.

The encrypted VoIP channel of the present invention enables a secure communication tunnel, or virtual private network (“VPN”), on a communication device completely within the user-space of the operating system. The invention allows a communication device such as a mobile phone to leverage secure and authenticated communications between the communication device and a server, or another communication device.

In one aspect, services from third party VoIP providers can be embedded/integrated in the system to obtain the encrypted VoIP service. Alternatively, a dedicated VoIP can be used to employ session control and signaling protocols to control the signaling, set-up, and tear-down of calls by using media delivery protocols that encode voice, audio, video with audio codecs, and video codecs as Digital audio by streaming media.

According to some embodiments of the present invention, as a mobile communication device, such as a smartphone, is registered at the system's server and its telephone number is associated with a current IP address provided to said device to enable data channel communication, the system's server stores said telephone number and the current IP address as to enable a third party to establish a data connection with the mobile device via usage of said telephone number to access current IP address associated with the mobile communication device, e.g., using a terminal device such as a PC. The telephone number can be associated to a textual representation (e.g., a name) visual representation (e.g., an image associated to a telephone number), etc., thereby enabling accessing the mobile communication device using said representations.

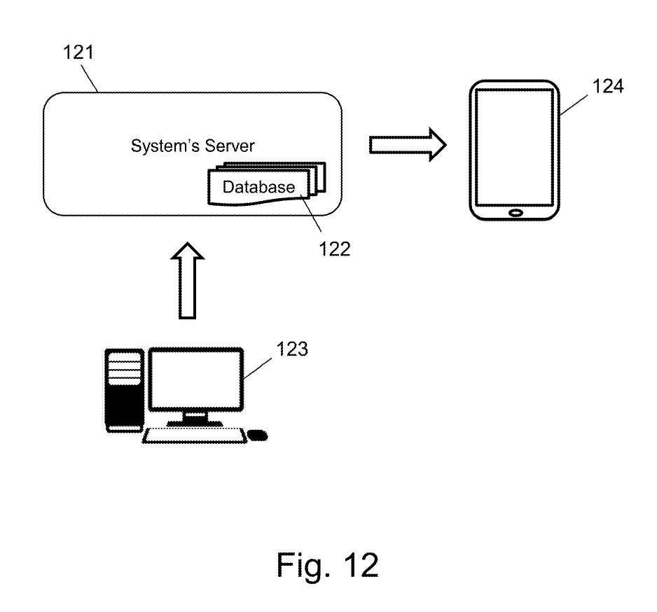

For example, FIG. 12 schematically illustrates a network access to a mobile communication device 124 and its resources and applications from a terminal device 123, e.g., via a server 121 associated with the system. According to some embodiments, an access from mobile communication device 124 to server 121, may trigger generation of a digital access token, access data string and/or other access indicator (i.e., “access token”) which may be usable by the terminal device 123, in order to gain digital access to mobile communication device 124 and to interact with one or more resources, services and/or applications running on mobile communication device 124. The access token may be stored in a database 122 (e.g., a networked token repository) which is accessible by any one of a set of possible external computing devices of a third party through a network such as the Internet, such as terminal device 123.

Each access token may include or otherwise be linked to a phone identifier (e.g. phone number, etc.) of the mobile device and the current IP address which either generated or otherwise triggered generation of the access token. The token may also include credentials for accessing the communication device. The token may also include encryption keys and/or parameters for accessing the communication device. The IP address may refer to a network addresses and/or network parameters for accessing the communication device.

According to an embodiment of the invention, an availability indicator can be used to notify whether a mobile communication device is accessible for data communication from the third party. For example, a user that appears on a contact list associated with the service of the present invention may be represented on terminal device 123 as available. Availability status is defined on server 121 when a mobile communication device has been acknowledged by server 121 as active for data communication, voice communication or both. The contact list may reside at terminal device 123, wherein terminal device 123 accesses server 121 to obtain the availability status of each contact in the list. Alternatively, a contact list may reside at server 121. In such embodiment, server 121 may notify terminal device 123 regarding the availability status of a contact. In a further embodiment, terminal device 123 can be used to connect, obtain the availability of any registered mobile device to server 121, by providing server 121 string representing a possible registered device via, e.g., typing, voice command, visual icon tapping, etc. The provided string is being sent to server 121 to establish a communication with the mobile device associate with the provided string.

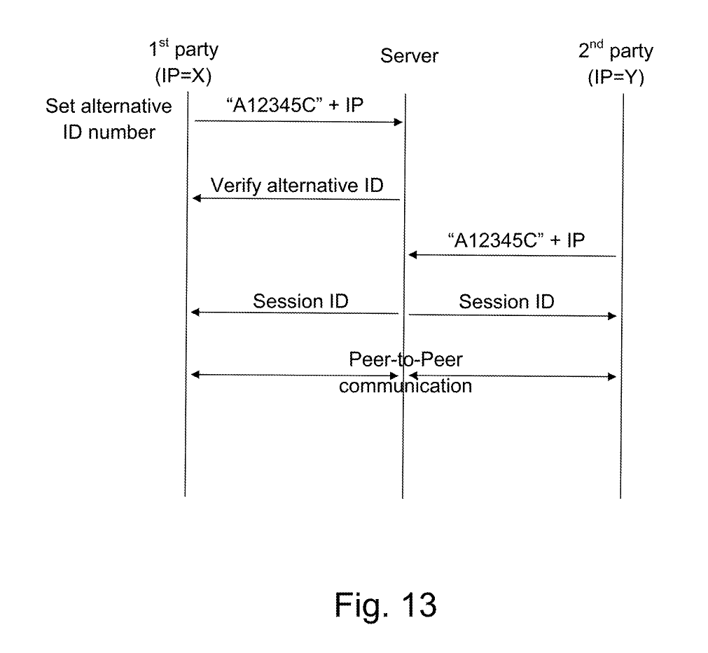

Referring now to FIG. 13, according to an embodiment of the invention, the system enables peer-to-peer communication, by allowing opening a private communication channel that is established and routed in real-time via the system's server, wherein a user provides the system with an alternative ID number to actual telephone number of that user. The alternative ID number can be provided to other user that in turn may communicate via the private communication channel by providing the alternative ID number to be matched and accordingly establishing a communication via providing each party the session ID for the private communication channel. For example, a first party provides an alternative ID number of his choice (e.g., “A12345C”, if the provided alternative ID number is not occupied, the system will verify the ID number and will allow such registration) to the system's server. The first party provides a second party the alternative ID number (e.g., via any communication means, such as regular phone call, frontal conversation, data messaging, etc.). As the second party also provides the system's server the alternative ID number, a private communication channel can be established between both parties on the fly using the presumed identity and the IP address of each entity.

The ability to generate an alternative ID can be associated by providing a predetermined code that may allow users to deploy the alternative ID. For example, a first user gets from a company a unique code that he might use prior to creation of the alternative ID. The alternative ID may have a limited functionally, e.g., can be used only for a limited period of time (e.g., few hours only, days, geographical location, etc.).

It is to be understood that both the foregoing general description and the following detailed description are exemplary and explanatory only and are not restrictive of the invention, as claimed.

1. A system for providing a digital service on a mobile communication device, said system comprising:
a dial pad or dialer interception module to detect a phone number dialed at the mobile communication device;
a lookup module to check whether the detected number is associated with a digital service and to retrieve digital service initiation parameters associated with an associated digital service.

2. The system according to claim 1, further comprising a digital service communication module on the mobile communication device adapted to engage in a digital service communication session with, and receive digital service from, a digital service communication module on service provider equipment.

3. The system according to claim 2, wherein said digital service communication module is adapted to engage in the digital service communication session either directly with the service provider or a through a digital service gateway.

4. A method for providing a digital service on a mobile communication device, said system comprising: providing access from a mobile communication device to a server to trigger generation of a digital access token which may be usable by a terminal device, in order to gain digital access to said mobile communication device and to interact with one or more resources, services and/or applications running on said mobile communication device, wherein said access token is stored in a database which is accessible by said terminal device through a network, thereby enabling data channel communication to be established between said terminal and said mobile communication device.

5. A method according to claim 4, wherein the server stores the telephone number and the current IP address of the mobile device as to enable a third party to establish data connection with said mobile device via usage of said telephone number to access current IP address associated with the mobile communication device.
